(19) United States
(12) Patent Application Publication
(10) Pub. No.: US 2026/0260580 A1
(43) Pub. Date: Sep. 3, 2026

(54) TOOL FOR LEARNING SPHERICAL DESIGN, AND METHODS FOR USING AND MANUFACTURING SAME

(71) Applicant: Ik Soo IM, Seoul (KR)

(72) Inventor: Ik Soo IM, Seoul (KR)

(21) Appl. No.: 19/156,207

(22) PCT Filed: Jan. 24, 2024
(86) PCT No.: PCT/KR2024/001150

§ 371 Date: Aug. 13, 2025

(30) Foreign Application Priority Data
Feb. 14, 2023 (KR) 10-2023-0019245

(51) Int. Cl. G09B 23/04; A63H 33/42

(52) U.S. Cl. CPC G09B 23/04; A63H 33/42

(57) ABSTRACT

Disclosed in the present invention are a tool for learning spherical design and methods for using and manufacturing same, the tool enabling the difficult mathematical concept of a regular polyhedron to be learned while performing tessellation, which is a form of artistic creation, thus enabling mathematical learning to enhance spatial abilities as well as creativity.

### CROSS-REFERENCE TO RELATED APPLICATION(S)

This is a National Stage of International Application No. PCT/KR2024/001150 filed Jan. 24, 2024, claiming priority to and the benefit of Korean Patent Application No. 10-2023-0019245, filed on Feb. 14, 2023, the entire contents of which are incorporated herein by reference.

### TECHNICAL FIELD

The present invention relates to a tool for leaning spherical design, and methods for using and manufacturing same.

### BACKGROUND ART

Spatial ability is a mental process of perceiving, recalling, creating, and communicating images of objects in space. The spatial ability requires elements such as spatial visualization of imaging the movement of objects in space, spatial orientation of measuring the direction without being confused by changes in the visual rotation direction of objects, and spatial relationship of quickly and accurately rotating objects in space in the mind.

The spatial ability significantly influences students' understanding of mathematics and science subjects. In order to improve such spatial ability, understanding the concepts themselves needs precede and learning through formal or verbal definitions leads to misconceptions.

A regular polyhedron is a regular polygon with all faces congruent, is a three-dimensional figure with the same number of faces meeting at each vertex, and has only five types: a regular tetrahedron, a cube, a regular octahedron, a regular dodecahedron, and a regular icosahedron. Geometry learning related to regular polyhedra can develop spatial ability because it involves three-dimensional figures using a three-dimensional space. However, learning using only two-dimensional textbooks, such as Patent Document 1, may lead to difficulties in correct understanding.

Patent Document 2 presents a tool in the form of a net to help understanding of regular polyhedra in a three-dimensional space. Such a tool is limited to regular polyhedra. Since the level of understanding of space varies significantly across grade levels, such a tool may fail to generate much interest in middle and high school lessons.

Consequently, by using a three-dimensional dynamic geometry program that can manipulate regular polyhedra by itself, mentally rotating, transforming, and manipulating vertices and edges of the regular polyhedron can enhance visualization ability and problem-solving skills compared to using the two-dimensional tools.

The present invention provides a new conceptual tool that allows simultaneous teaching of mathematics and art by simply introducing artistic techniques such as tessellation as well as understanding of the concept of regular polyhedra.

Tessellation means perfectly covering a plane or a space with figures without any gaps or overlaps, and refers to an artistic technique utilizing congruent concepts such as rotation, symmetry, and translation that are applied in mathematics lesson.

For example, various repetitive patterns can be found on bathroom tiles or floors. In the process of learning such tessellation, mathematical concepts can be naturally acquired, the division of space can be naturally understood, and interest in mathematics can be increased.

It is conventional that most tessellation education is done with polyhedron making sets using paper, wooden tangram puzzles, Soma cubes, and polyhedron blocks, and is mainly performed on a flat surface.

Sphere tessellation can provide many intuitive concepts about space because repetitive identical patterns need be formed on a sphere, and can further develop a sense of space, thereby acquiring the concept of three-dimensional geometry rather than plane geometry.

The sphere tessellation is done by drawing vertices on a sphere by using a writing instrument, connecting the vertices by using a protractor or the like, or by creating repetitive patterns inclusive of the vertices. In such a case, learners can achieve various shapes such as a soccer ball by creative ideas. Accordingly, spatial awareness can be developed by adjusting the number of vertices to suit the learner's level.

However, in conventional sphere tessellation, since vertices or the like are directly drawn on a sphere to connect lines, it is difficult to accurately mark vertices in specific locations due to the sphere's inherent properties that is not fixed during use.

The present invention provides a new tool to facilitate the learning of spherical tessellations.
(Patent Document 1) Korea Patent No. 10-11121650000 (Jan. 27, 2012)
(Patent Document 2) Korea Utility Model No. 20-04886270000 (Feb. 25, 2019)

### DISCLOSURE

### Technical Problem

An object of the present invention is to provide a tool that can assist the understanding of geometric concepts of regular polyhedra by introducing regular polyhedra onto a sphere and forming repetitive patterns, and develop creativity by creating various patterns.

When vertices of regular polyhedra are directly marked on a sphere, it is difficult for the vertices to be accurately marked due to the properties of the sphere. When the vertices are not accurately marked, even though straight lines, curves, and the like are connected, it is difficult express repetitive patterns. In addition, a long time is required for marking the vertices of the regular polyhedra on the sphere.

The present invention provides a tool that allows vertices to be accurately marked on a sphere without the need for separate fixing, thereby enabling easy representation of various straight and curved lines. Also, it is provided a program that allows learners to create the tool themselves, thereby enhancing their understanding of geometry and problem-solving skills.

### Technical Solution

The present invention provides a tool of spherical design play or learning for learners.

FIG. 1 is a diagram for explaining a tool.

Referring to FIG. 1, a tool 100 includes a spherical housing 10 including a first hemisphere 11 and a second hemisphere 13 that are detachably coupled to each other, are coupled to each other to form a sphere, and form a spherical receiving space therein.

The first hemisphere 11 and the second hemisphere 13 are prepared in a hemispherical shape for coupling, and an end region of a portion where they are coupled to each other has a straight or curved shape. For example, the end region may have a straight, wavy, or zigzag shape.

In accordance with one embodiment, either a convex rib or a concave rib is formed at the end of each of the first hemisphere 11 and the second hemisphere 13, so that the first hemisphere 11 and the second hemisphere 13 can be substantially coupled to each other. That is, the convex rib may be formed at the end of the first hemisphere 11 and the concave rib may be formed at the end of the second hemisphere 13, or the concave rib may be formed at the end of the first hemisphere 11 and the convex rib may be formed at the end of the second hemisphere 13. The presence of the convex rib and the concave rib facilitates the fixing of the inner sphere 20 within the spherical housing 10, thereby further facilitating the marking of vertices via through holes 15.

In accordance with another embodiment, the first hemisphere 11 and the second hemisphere 13 form the spherical housing 10 without separate convex ribs or concave ribs. In such a case, the ends of the first hemisphere 11 and the second hemisphere 13 have a wavy or zigzag shape, and this interlocking shape enables the fixing of the inner sphere within the housing.

The first hemisphere 11 and the second hemisphere 13 have a plurality of through holes 15 that can mark vertices on the inner sphere 20.

The vertex is an arbitrary point on the surface of the inner sphere 20, and this point serves as a pole Pa, and an equator E is a great circle that divides the sphere into northern and southern hemispheres based on the pole Pa. Accordingly, the center of the first hemisphere 11 or the second hemisphere 13 is the pole Pa, and the first hemisphere 11 and the second hemisphere 13 are divided based on the equator E.

The through hole 15 is formed in the first hemisphere and the second hemisphere. When the vertex is marked at the equator E, a hemispherical through hole 15a with one end open is formed in the first hemisphere 11, and a hemispherical through hole 15b with one end open is formed in the second hemisphere 13 coupled to the first hemisphere 11.

The coupling of the first hemisphere 11 and the second hemisphere 13 completes one through hole 15.

The inner sphere 20 is mounted in a receiving space within the spherical housing and the vertex is marked using a writing instrument.

The inner sphere 20 can be made of any material capable of marking vertices and patterns using a writing instrument. Examples of the material include plastic, Styrofoam, wood, and rubber.

The writing instrument can be any tool, such as a pencil, a ballpoint pen, or a marker pen, that can mark vertices on the inner sphere 20 through the through holes 15 and draw patterns on the inner sphere 20.

The tool 100 according to the present invention can accurately draw vertices on the inner sphere 20 through the through holes 15, making it easy to obtain repetitive patterns of the same shape through straight and curved connections. In addition, as the number of through holes 15 varies, the number of vertices can also be variously obtained, so that various patterns can be obtained by learners' creative abilities.

The through holes 15 are located at vertices of various regular polyhedra forming the inner sphere 20. This enables understanding of the types and properties of regular polyhedra and can obtain shape transformations according to the combination of regular polyhedra by applying the concept of equal division.

There are five regular polyhedra: a regular tetrahedron, a cube, a regular octahedron, a regular dodecahedron, and a regular icosahedron. The total number of faces, the number of vertices, and the number of edges are as shown in FIG. 13.

The regular tetrahedron has four vertices, with three faces meeting at each vertex. Therefore, the centers of adjacent faces at each vertex are connected to form an equilateral triangle.

The cube has eight vertices, with three faces meeting at each vertex. Therefore, the centers of adjacent faces at each vertex are connected to form an equilateral triangle.

The regular octahedron has six vertices, with four faces meeting at each vertex. Therefore, the centers of adjacent faces at each vertex are connected to form a square.

The regular dodecahedron has 20 vertices, with three faces meeting at each vertex. Therefore, the centers of adjacent faces at each vertex are connected to form an equilateral triangle.

The regular icosahedron has 12 vertices, with five faces meeting at each vertex. Therefore, the centers of adjacent faces at each vertex are connected to form a regular pentagon.

The vertices at various locations can be displayed on the inner sphere 20 through the plurality of through holes 15 formed in the first hemisphere and the second hemisphere.

In such a case, various creative repetitive patterns can be implemented by connecting the vertices with straight or curved lines or by expressing a specific shape.

In addition, various shapes can be implemented even in one tool.

That is, the regular polyhedra differ in the shape of face, the number of faces meeting at each vertex, the number of faces, the number of vertices, the number of edges, and the like, but there is a cyclic nature among the regular polyhedra upon the detailed examination.

The number of faces of the regular icosahedron is equal to the number of vertices of the regular dodecahedron, the number of faces of the regular dodecahedron is equal to the number of edges of the cube, the number of faces of the cube is equal to the number of edges of the regular tetrahedron, the number of edges of the regular tetrahedron is equal to the number of vertices of the regular octahedron, and the number of edges of the regular octahedron is equal to the number of vertices of the regular icosahedron. Accordingly, the regular dodecahedron can be created using the centers of the faces of the regular icosahedron, the cube can be created using the diagonals of the faces of the regular dodecahedron, the regular tetrahedron can be created using the diagonals of the faces of the cube, the regular octahedron can be created using the midpoints of the edges of the regular tetrahedron, and the regular icosahedron can be created using the partition points of the edges of the regular octahedron.

As a specific example, the cube and the regular octahedron are dual polyhedra, and the regular dodecahedron and the regular icosahedron are dual polyhedra. The dual polyhedron refers to a polyhedron created using the centers of each face as their vertices. Due to such characteristics, the dual polyhedron of a dual polyhedron of a polyhedron is an original polyhedron. Since the regular octahedron {3, 4} has four equilateral triangles meeting at each vertex, it is the dual figure of the cube {4, 3} having three squares meeting at each vertex. Since the regular dodecahedron {5, 3} has three regular pentagons meeting at each vertex, it is the dual figure of the regular icosahedron {3, 5} having five equilateral triangles meeting at each vertex. Accordingly, even though the through hole is formed to implement a cube, a regular octahedron can be implemented.

This is possible even in polyhedra that are not dual polyhedra.

For example, connecting points obtained by a golden section of each edge of a regular octahedron creates a regular icosahedron. Selectively connecting eight non-adjacent vertices among 20 vertices of a regular dodecahedron creates a cube. In addition, selectively connecting four vertices among 20 vertices of a regular dodecahedron as appropriate can create a regular tetrahedron.

In the above, only the vertices of the regular tetrahedron, the cube, the regular octahedron, the regular dodecahedron, and the regular icosahedron have been described.

However, the through holes 15 for forming them have been described as being present within one spherical housing 10.

In accordance with a further embodiment, all the through holes 15 required for the regular polyhedra are present within one spherical housing 10. This allows for the implementation of various regular polyhedra within one inner sphere 20 with one spherical housing 10, or for the implementation of individual regular polyhedra within several inner spheres 20 by replacing the inner spheres 20.

In accordance with another embodiment, the through holes 15 corresponding to the vertices of a cube and a regular octahedron in a dual polyhedron relationship are created within one spherical housing 10, and the through holes 15 are used to create a cube and a regular octahedron within the inner sphere 20, thereby enhancing the understanding of dual polyhedra.

According to further another embodiment, the through holes 15 corresponding to the vertices of a regular dodecahedron and a regular icosahedron in a dual polyhedron relationship are created in one spherical housing 10, and the through holes 15 are used to create a regular dodecahedron and a regular icosahedron within the inner sphere 20, thereby enhancing understanding of dual polyhedra.

In the above, only the vertices of the regular tetrahedron, the cube, the regular octahedron, the regular dodecahedron, and the regular icosahedron have been described. However, in addition to the through holes 15 for these vertices, when additional through holes 15 are formed in the first hemisphere and the second hemisphere, figures or patterns other than regular polyhedra can be drawn. The number of additional through holes 15 formed in the first hemisphere and the second hemisphere is not limited and can be added by a learner. However, the additional through holes 15 formed in the first hemisphere 11 and the second hemisphere 13 are preferably formed at symmetrical locations for a repeatable pattern.

Play or lesson using the tool of the present invention can be conducted in various ways.

One method includes the following steps of:
S1) coupling the first hemisphere 11 and the second hemisphere 13 each having the through hole 15 to the inner sphere 20;
S2) marking vertices of a regular polyhedron on the surface of the inner sphere by using the through hole 15; and
S3) separating the inner sphere 20 having the marked vertices and then using the vertices to obtain a regular polyhedron or a repetitive pattern using the same.

A regular polyhedron can be represented on the sphere by simply connecting the vertices. One regular polyhedron drawn on the inner sphere 20 can be subjected to an additional task related to the property “cycle of a regular polyhedron”, which allows for the continuous creation of new regular polyhedra within the regular polyhedron, thereby representing a cube, a regular tetrahedron, a regular octahedron, a regular dodecahedron, and a regular icosahedron on one inner sphere 20.

In addition to such a regular polyhedron, tasks can be performed using tessellations. That is, by representing lines such as curves or surfaces based on vertices, a repetitive pattern expressed as a tessellation can be obtained. That is, by finding the vertices of a regular polyhedron, connecting the vertices, and using patterns, tasks can be performed with various balls used in ball sports, such as soccer balls, volleyballs, and baseballs. For example, tasks can be performed with the official World Cup balls, such as the Telstar, Teamgeist, Jabulani, Brazuca, and Al Rihla, thereby enhancing learner' academic achievement.

In addition to the above-mentioned lessons, a lesson can be conducted using a three-dimensional geometry program and a three-dimensional printer to directly prepare the spherical housing 10 among tools.

The method for manufacturing the tool 100 of the present invention includes the following steps of:
P1) finding vertices of a regular polyhedron by using a three-dimensional geometry program;
P2) modeling a first hemisphere and a second hemisphere by using a three-dimensional modeling program so that the vertices form through holes 15;
P3) adjusting diameters of the first hemisphere and the second hemisphere by using the three-dimensional modeling program according to a diameter of the inner sphere 20;
P4) preparing the modeled first and second hemispheres using a three-dimensional printer; and
P5) providing a set of the first hemisphere and the second hemisphere and the inner sphere that can be accommodated in a receiving space formed by mutual coupling of the first hemisphere and the second hemisphere.

The tool set obtained through steps P1) to P5) can be used to conduct the lessons described in steps S1) to S3).

The following describes in details the manufacturing of the tool.

First, a lesson using the three-dimensional geometry program begins with finding the vertices for forming the through holes 15 within the spherical housing 10 (P1).

FIG. 2 is a diagram showing how to find the vertices of a regular octahedron. As shown in FIG. 2 (a), when a square BCDE with a side length of \sqrt{2} is drawn on a plane and its center is denoted as O, OB=OC=OD=OE=1. In such a case, a perpendicular line is drawn from the center O to be perpendicular to the square BCDE and points A and F, where OA=1 and OF=1, are located on opposite sides of the square. In this way, six points A, B, C, D, E, and F become the vertices of the regular octahedron. When a sphere with a center O and a radius 1 is drawn, the vertices A, B, C, D, E, and F of a regular octahedron as shown in FIG. 2 (b) are all located on the sphere.

FIG. 3 is a diagram showing how to find the vertices of a cube. Since the cube is a dual polyhedron of the regular octahedron, the drawing of the regular octahedron is referenced.

Referring to FIG. 3 (a), when the centroids of four triangles ABC, ACD, ADE, and AEB in a regular octahedron A-BCDE-F are G, H, I, and J, respectively, and the centroids of four triangles FBC, FCD, FDE, and FEB are K, L, M, and N, respectively, the eight points G, H, I, J, K, L, M, and N are eight vertices of the cube.

As shown in FIG. 3 (b), when the intersection points of eight half lines \vec{OG}, \vec{OH}, \vec{OI}, \vec{OJ}, \vec{OK}, \vec{OL}, \vec{OM}, \vec{ON} and the spherical surface of a sphere with a radius 1 are P, Q, R, S, T, U, V, and W, respectively, these points are also eight vertices of a cube. This is because the center of the regular octahedron is O and the center of the cube GHIJ-KLMN as a dual polyhedron is also O. Accordingly, \vec{OG}=\vec{OH}=\vec{OI}=\vec{OJ}=\vec{OK}=\vec{OL}=\vec{OM}=\vec{ON}.

Since ∠AGO=90° in the regular octahedron,

$$OG = \sqrt{{OA}^{2} - {AG}^{2}} = \sqrt{{1}^{2} - {( \frac{2}{3} \cdot \frac{\sqrt{3}}{2} \cdot \sqrt{2} )}^{2}} = \frac{1}{\sqrt{3}}$$

is obtained.

Therefore, as shown in FIG. 3 (c), when points magnified by \sqrt{3} times the eight points G, H, I, J, K, L, M, and N around the point O are P, Q, R, S, T, U, V, and W, respectively, these eight points form a cube, and the lengths of \vec{OP}, \vec{OQ}, \vec{OR}, \vec{OS}, \vec{OT}, \vec{OU}, \vec{OV}, \vec{OW} are all 1. Accordingly, the eight points P, Q, R, S, T, U, V, and W are located on the sphere with a radius 1 and are the vertices of the cube.

FIG. 4 is a diagram showing how to find the vertices of a regular tetrahedron. In the cube PQRS-TUVW, four vertices P, R, U, and W form a regular tetrahedron and the remaining four vertices, Q, S, T, and V also form a regular tetrahedron.

In addition, the four points Q, S, T, and V are the spherical centers of spherical triangles divided by the four vertices P, R, U, and W of the regular tetrahedron.

FIG. 5 is a diagram showing how to find the vertices of a regular dodecahedron.

It is possible to use the property that eight vertices selected from the twenty vertices of a regular dodecahedron serve as eight vertices of a cube. That is, a regular dodecahedron exists whose vertices are the eight points P, Q, R, S, T, U, V, and W that form the cube.

First, as shown in FIG. 5 (a), the eight points P, Q, R, S, T, U, V, and W are eight of the 20 vertices of the regular dodecahedron.

The other 12 vertices of the regular dodecahedron are denoted as D₁, D₂, D₃, . . . , D₁₂.

Method for finding point D₁: when a circle with a center P and a radius P̅S̅ and a circle with a center Q and a radius Q̅R̅ are drawn on the spherical surface of a sphere with a center O and a radius 1, the intersection point of the two circles is D₁.

Method for finding point D₂: when a circle with a center S and a radius S̅P̅ and a circle with a center R and a radius R̅Q̅ are drawn on the spherical surface of a sphere with a center O and a radius 1, the intersection point of the two circles is D₂.

This process can be continued to obtain D₃, . . . , D₁₂.

That is, as shown in FIG. 5 (b), the 20 vertices of the regular dodecahedron, that is, P, Q, R, S, T, U, V, W, D₁, D₂, D₃, . . . , D₁₂ are all located on the spherical surface of a sphere with a center O and a radius 1.

This is because in a regular pentagon PD₂D₁SD₅, P̅D̅₁̅=P̅S̅ and in a regular pentagon QD₂D₁RD₇, Q̅D̅₁̅=Q̅R̅. Accordingly, on the spherical surface of a sphere with a center O and a radius 1, the intersection point of the circle with a center P and a radius P̅S̅ and the circle with a center Q and a radius Q̅R̅ is D₁.

In the regular pentagon PD₂DISD₅, S̅D̅₂=S̅P̅ and in the regular pentagon QD₂D₁RD₇, R̅D̅₂̅=R̅Q̅. Accordingly, on the spherical surface of a sphere with a center O and a radius 1, the intersection point of the circle with a center S and a radius S̅P̅ and the circle with a center R and a radius R̅Q̅ is D₂.

Method for finding point D₅: when a circle with a center W and a radius W̅S̅ and a circle with a center T and a radius T̅P̅ are drawn on the spherical surface of a sphere with a center O and a radius 1, the intersection point of the two circles is D₅. This is because in a regular pentagon SD₅D₆WD₁₁, W̅D̅₅̅=W̅S̅ and in a regular pentagon PD₅D₆TD₉, T̅D̅₅̅=T̅P̅. Accordingly, on the spherical surface, an intersection point of the circle with a center W and a radius W̅S̅ and the circle with a center T and a radius T̅P̅ is D₅.

FIG. 6 is a diagram showing how to find the vertices of a regular icosahedron. A solid obtained by connecting the centers of faces of the regular dodecahedron forms a regular icosahedron as a dual polyhedron.

FIG. 6 (a) obtained above uses the 20 vertices of the regular dodecahedron in FIG. 5 (b), that is, P, Q, R, S, T, U, V, W, D₁, D₂, D₃, . . . , D₁₂.

As shown in FIG. 6 (c), when the centers of twelve regular pentagons of the regular dodecahedron are denoted as I₁, I₂, . . . , I₁₂, and the intersection points of twelve half lines \vec{OI₁}, \vec{OI₂}, . . . , \vec{OI₁₂} and the spherical surface of a sphere with a center O and a radius 1 are denoted as X₁, X₂, . . . , X₁₂, respectively, twelve points X₁, X₂, . . . , X₁₂ are the vertices of the regular icosahedron.

Since the solid obtained by connecting the centers of faces of the regular dodecahedron forms a regular icosahedron as a dual polyhedron, the twelve centers I₁, I₂, . . . , I₁₂ of the regular dodecahedron are the vertices of the regular icosahedron, and the center of the regular icosahedron is the same as the center O of the regular dodecahedron.

Since O̅I̅₁̅=O̅I̅₂̅= . . . O̅I̅₁̅₂̅, the figure formed by the intersection points X₁, X₂, . . . , X₁₂ of O̅I̅₁̅, O̅I̅₂̅, . . . , O̅I̅₁̅₂̅ and the spherical surface of the sphere with a center O and a radius 1 is similar to the solid formed by the twelve points I₁, I₂, . . . , I₁₂. That is, the 12 points X₁, X₂, . . . , X₁₂ are the vertices of the regular dodecahedron.

Subsequently, by using a three-dimensional modeling program, the first hemisphere and the second hemisphere are modeled so that the vertices form the through holes 15 (P2).

Programs for three-dimensional modeling include Solidworks, CATIA, Rhino, Inventor, three-dimensional (3D) Max, Sketch Up, Z-Brush, Blender, and the like, and an appropriate program is used in consideration of learner's age and the like.

FIG. 7 is an image showing the through holes 15 corresponding to all the vertices constituting five regular polyhedra through three-dimensional modeling. Referring to FIG. 7, a total of 38 through holes 15 are expressed on the sphere, and this three-dimensional modeling is used to prepare the spherical housing 10.

In such a case, in the spherical housing 10, the number and location of through holes 15 can be adjusted depending on the type of regular polyhedron, or the through holes can be formed to encompass all regular polyhedra as shown in FIG. 7.

Subsequently, the diameters of the first hemisphere 11 and the second hemisphere 13 are adjusted using the three-dimensional modeling program according to the diameter of the inner sphere 20 (P3).

Subsequently, the modeled first and second hemispheres 11 and 13 are prepared using a three-dimensional printer (P4).

The three-dimensional (3D) printing is an additive manufacturing method for creating a desired shape by sequentially stacking materials layer by layer based on three-dimensional digital data obtained through scanning or modeling.

The spherical housing 10 (first and second hemispheres) can be designed using the three-dimensional modeling technique and printed using the three-dimensional printer to prepare the tool. In such a case, the first hemisphere 11 and the second hemisphere 13 can be designed and prepared separately, or a coupled spherical housing 10 is prepared and then cut to prepare the first hemisphere 11 and the second hemisphere 13.

In the tool according to the present invention, after lesson, the spherical housing can be reused and the used inner sphere 20 can be replaced with a new one, so that the tool can be reused. This allows the preparation of spheres with several repetitive patterns by using one spherical housing 10.

### Advantageous Effects

The tool presented by the present invention combines the difficult mathematical concept of a regular polyhedron with the artistic creation of tessellation, thereby enhancing spatial abilities and creativity in mathematics learning.

In addition, a three-dimensional geometry program is used to find vertices, a mathematical image of a regular polyhedron is actually converted into data, and the data is implemented as output by using three-dimensional printing to directly prepare a tool, so that various repetitive patterns capable of allowing learners to understand regular polyhedra and cyclicality and show individuality can be prepared, thereby obtaining a positive effect in terms of understanding and inducement of interest of the learners.

### BRIEF DESCRIPTION OF DRAWINGS

FIG. 1 is a perspective view showing the tool of the present invention according to one embodiment.

FIG. 2 is a diagram showing how to find the vertices of a regular octahedron on a sphere.

FIG. 3 is a diagram showing how to find the vertices of a cube on a sphere.

FIG. 4 is a diagram showing how to find the vertices of a regular tetrahedron on a sphere.

FIG. 5 is a diagram showing how to find the vertices of a regular dodecahedron on a sphere.

FIG. 6 is a diagram showing how to find the vertices of an icosahedron on a sphere.

FIG. 7 is an image showing through holes corresponding to all vertices constituting five regular polyhedra through three-dimensional modeling.

FIG. 8 is a diagram showing a process of preparing a soccer ball pattern similar to Teamgeist by using the vertices of an inner sphere.

FIG. 9 shows the preparation of a volleyball-like design by using the vertices of an inner sphere.

FIG. 10 shows the preparation of a Jabulani-like design by using the vertices of an inner sphere.

FIG. 11 shows the preparation of a star-shaped soccer ball design by using the vertices of an inner sphere.

FIG. 12 shows the preparation of a windmill-like design with five wings by using the vertices of an inner sphere.

FIG. 13 shows the total numbers of faces, vertices, and edges of regular polyhedra including a regular tetrahedron, a cube, a regular octahedron, a regular dodecahedron, and a regular icosahedron.

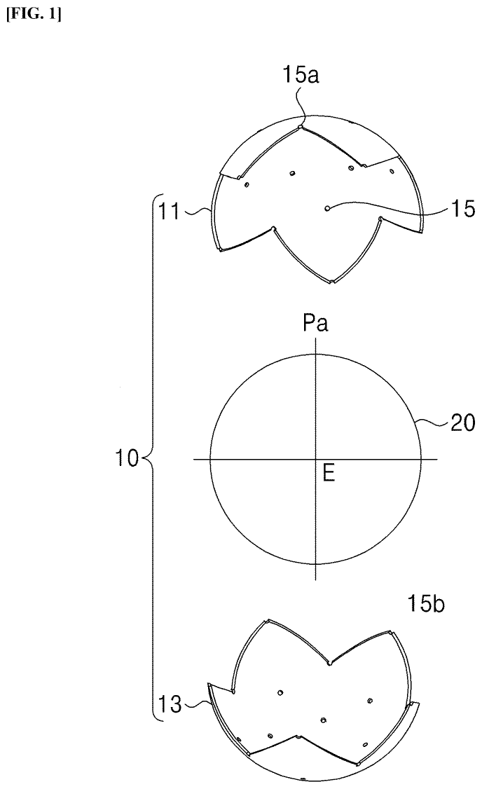

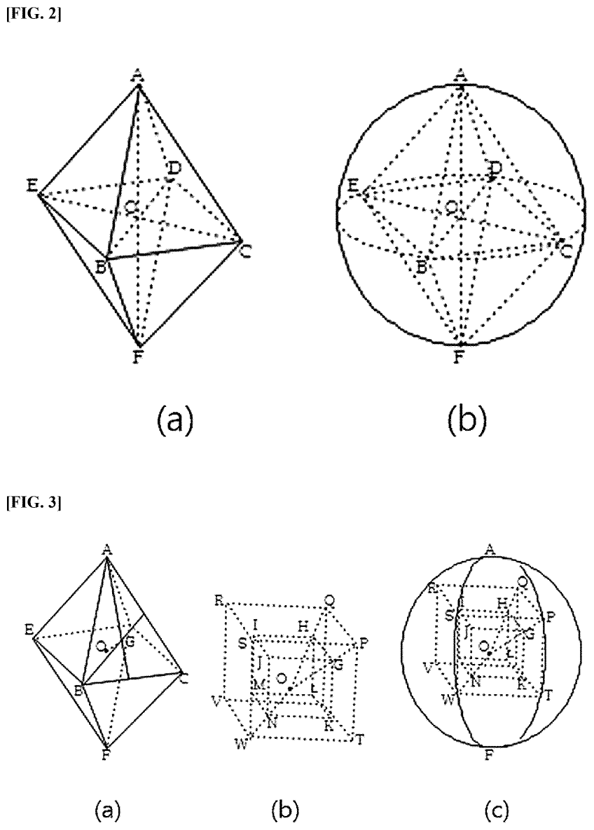

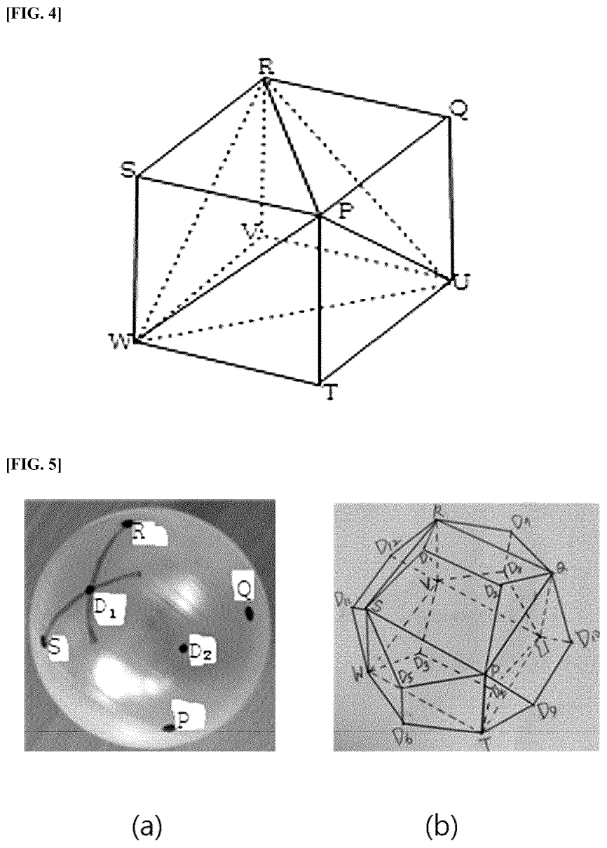

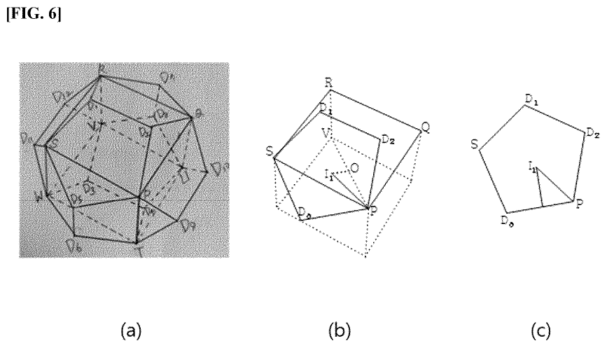

### BEST MODE

In accordance with one embodiment of the present invention, the present invention is directed to a tool of spherical design play or learning for a learner including:

a spherical housing including a first hemisphere and a second hemisphere that are detachably coupled to each other, are coupled to each other to form a sphere, and form a spherical receiving space therein; and an inner spere mounted in the receiving space within the spherical housing, wherein the first hemisphere and the second hemisphere include a plurality of through holes.

In accordance with another embodiment of the present invention, the present invention is directed to a method for using a tool of spherical design, the method including steps of: S1) coupling a first hemisphere and a second hemisphere each having a through hole to an inner sphere;
S2) marking vertices of a regular polyhedron on a surface of the inner sphere by using the through hole; and
S3) separating the inner sphere having the marked vertices and using the vertices to obtain a regular polyhedron or a repetitive pattern using the regular polyhedron.

In accordance with another embodiment of the present invention, the present invention is directed to a method for manufacturing a tool of spherical design, the method including steps of: P1) finding vertices of a regular polyhedron by using a three-dimensional geometry program;
P2) modeling a first hemisphere and a second hemisphere by using a three-dimensional modeling program so that the vertices form through holes;
P3) adjusting diameters of the first hemisphere and the second hemisphere by using the three-dimensional modeling program according to a diameter of an inner sphere;
P4) preparing the modeled first and second hemispheres having the through holes using a three-dimensional printer; and
P5) providing a set of the first hemisphere and the second hemisphere and the inner sphere that can be accommodated in an accommodating space formed by mutual coupling of the first hemisphere and the second hemisphere.

### MODE FOR INVENTION

### Preparation Example: Preparation of Tool

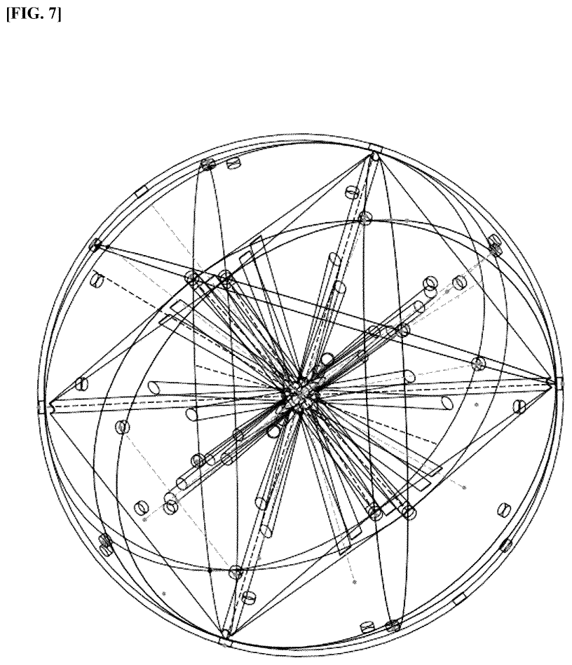

A three-dimensional geometry program was used to find the vertices of five regular polyhedra, and a three-dimensional modeling program was used to obtain the image shown in FIG. 7. By using the image, a spherical housing was prepared through various types of three-dimensional printing. In such a case, as inner sphere, a translucent plastic sphere was used to facilitate confirmation of marked vertices.
Group 1: Spherical housing formed with through holes corresponding to the vertices of each regular polyhedron.
Group 2: Spherical housing simultaneously formed with through holes corresponding to the vertices of a cube/a regular octahedron, and a spherical housing simultaneously formed with through holes corresponding to the vertices of a regular dodecahedron/a regular icosahedron.
Group 3: Spherical housing simultaneously formed with through holes corresponding to all vertices shown in FIG. 7.

### Example 1: Design Using Vertices of Regular Octahedron

Spherical housing (first and second hemispheres) marked with six through holes was prepared using a three-dimensional printer, and then vertices were marked on a transparent inner sphere.

FIG. 8 is a diagram showing a process of preparing a soccer ball pattern similar to Teamgeist by using the vertices of an inner sphere.

As shown in FIG. 8 (a), a dumbbell-shaped pattern was drawn around six vertices of a regular octahedron. This assumes that when the six vertices of the regular octahedron are denoted as N, A, B, C, D, and S, points N and S are North and South Poles, the four points A, B, C, and D are located on the equator, and a square is formed in this order. Two adjacent vertices of the regular octahedron are connected with a great circle path. Points K and L, which satisfy

$$\text{?} = \text{?} \text{?} \text{?} \text{?} = \text{?} \text{?}$$

$$\text{?} \text{indicates text missing or illegible when filed}$$

are located on an arc [symbol] , respectively. An arc centered at the point K and passing through the point L is drawn. This task is also performed on an arc [symbol] side. Point M is located on an arc [symbol] to satisfy

$$\text{?} = \text{?} \text{?}$$

$$\text{?} \text{indicates text missing or illegible when filed}$$

and the two arcs and the point M are smoothly connected. This task is also performed on an arc [symbol] side. As a result, a dumbbell-shaped pattern can be obtained.

This process is also performed on the other vertices of the regular octahedron, and when the auxiliary lines are finally erased, the design shown in FIG. 8 (b) is obtained. Subsequently, by adding some curves corresponding to the great circle path connecting the vertices of the regular octahedron, FIG. 8 (c) is obtained.

When coloring is performed on FIG. 8 (c), a soccer ball pattern similar to Teamgeist as shown in FIG. 8 (d) can be obtained.

### Example 2: Design Using Vertices of Cube and Regular Octahedron

A spherical housing (first and second hemispheres) with 14 through holes 15 was prepared using a three-dimensional printer, and vertices were marked on a transparent inner sphere.

FIG. 9 shows the preparation of a volleyball-like design by using the vertices of an inner sphere.

As shown in FIGS. 9 (a) and (b), six vertices of a regular octahedron are denoted as N, A, B, C, D, and S, and any two adjacent vertices are connected by a great circle path. Points N and S are North and South Poles, the four points A, B, C, and D are located on an equator, and a square is formed in this order. In addition, eight vertices of a cube are denoted as P, Q, R, T, . . . , the point P is the spherical center of a spherical triangle NAB. Q, R, T, . . . are also the spherical centers of spherical triangles NBC, NCD, NDA, . . . , respectively.

When a circle centered at N and passing through point P is drawn, a circle centered at A and passing through point P is drawn, and a circle centered at B and passing through point P is drawn, FIG. 9 (a) is obtained. When this process is also performed for the points Q, R, and T, a figure connecting four points forming one face of the cube as shown in FIG. 9 (c) was created. The same process is repeated for points forming the other faces. The design connecting the eight vertices of the cube was completed, and the sphere was divided into six congruent figures.

Subsequently, as shown in FIG. 9 (d), when each figure is divided into three parts, a pattern similar to a volleyball shape as shown in FIG. 9 (e) can be obtained.

### Example 3: Design Using Vertices of Regular Tetrahedron

A spherical housing (first and second hemispheres) with eight through holes 15 corresponding to the vertices of a cube was prepared using a three-dimensional printer, and vertices were marked on a transparent inner sphere.

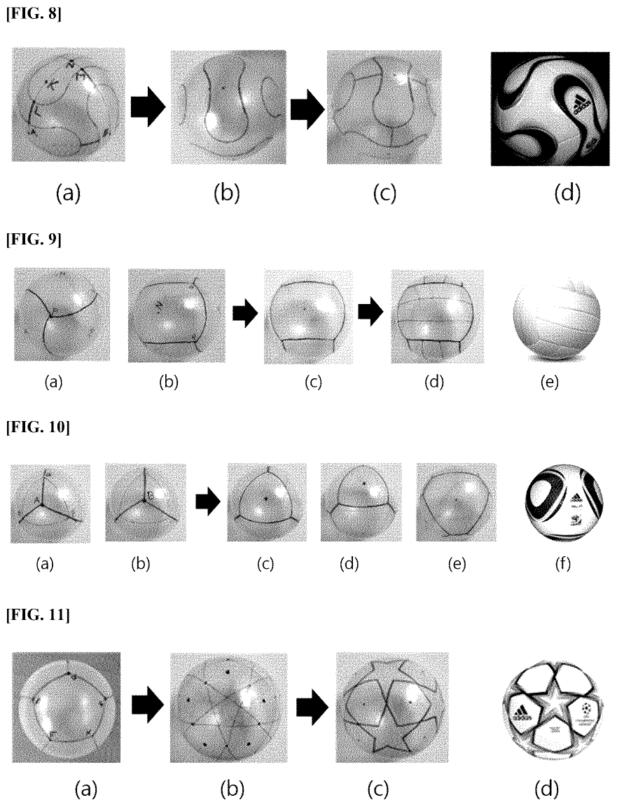

FIG. 10 shows the preparation of a Jabulani-like design being the official World Cup ball by using the vertices of an inner sphere.

As shown in FIGS. 10 (a) and (b), eight vertices of a cube are marked on the sphere, four vertices A, B, C, and D forming a regular tetrahedron are selected from the eight vertices, and the vertices are connected by great circle paths.

Points E, F, and G, which are ⅜ the length of an arc from vertex A to the other vertices of the regular tetrahedron, are selected. By using a compass, an arc centered at E and passing through F and G is drawn to select an arc [symbol] , an arc centered at F and passing through G and E is drawn to select an arc [symbol] , and an arc centered at G and passing through E and F is drawn to select an arc [symbol] .

Subsequently, when internal curves of a figure surrounded by the three arcs are erased, inner spheres as shown in FIGS. 10 (c) to (e) are obtained. When coloring is performed on the inner spheres, a pattern similar to the Jabulani as shown in FIG. 10 (f) can be obtained.

### Example 4: Design Using Vertices of Regular Dodecahedron

A spherical housing (first and second hemispheres) with 20 through holes 15 was prepared using a three-dimensional printer, and vertices were marked on a transparent inner sphere.

FIG. 11 shows the preparation of a star-shaped soccer ball design by using the vertices of an inner sphere.

As shown in FIG. 11 (a), 20 vertices (blue dots) forming a regular dodecahedron are marked on the sphere, and two adjacent vertices are connected by a great circle arc. Subsequently, midpoints of the two adjacent vertices on the sphere are marked with red dots. Each spherical pentagon has five such midpoints, and when respective two points are connected with a great circle arc, a star shape is obtained as shown in FIG. 11 (b).

The same process is also repeated for the remaining 11 spherical pentagons, and when star-shaped internal curves are erased, a shape as shown in FIG. 11 (c) is obtained. After coloring is performed on the shape, a shape as shown in FIG. 11 (d) can be obtained.

As shown in FIGS. 11 (c) and 10 (d), the sphere is filled with star-shaped figures (curved pentagrams) and figures with six curved sides (curved hexagons). The number of curved pentagrams is 12 and the number of curved hexagons is 20.

### Example 5: Design Using Vertices of Regular Icosahedron and Regular Dodecahedron

A spherical housing (first and second hemispheres) with 32 through holes 15 was prepared using a three-dimensional printer, and vertices were marked on a transparent inner sphere.

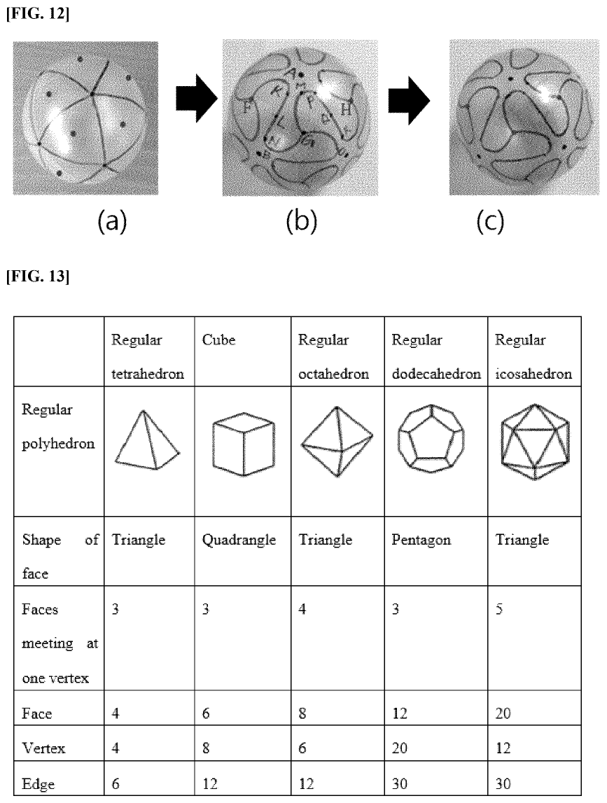

FIG. 12 shows the preparation of a windmill-like design with five wings by using the vertices of an inner sphere.

As shown in FIG. 12 (a), 12 vertices are connected to complete the regular icosahedron. In addition, vertices of the regular dodecahedron are the centers of spherical triangles divided into the vertices of the regular icosahedron.

Subsequently, as shown in FIG. 12 (b), one vertex of the regular icosahedron is denoted as A, vertices adjacent to A are written as B, C, D, . . . , and the vertices of the regular dodecahedron are written as F, G, H, . . . .

The center of the spherical triangle ABC on the sphere is G. Quartering points of a great circle arc [symbol] AB are denoted as K, L, and N and quartering points of a great circle arc [symbol] are denoted as P, Q, and R. In addition, the two points K and P are connected with a great circle arc, and the midpoint of the two points is denoted as M.

Subsequently, the point G and the point P are connected with a curve via the point M, and in the same way, the point G and the point N are connected with a curve (rotation of the curve GMP). A great circle arc [symbol] is selected. This creates a small curved figure that starts at the point K, passes through N, G, and M, and ends at the point P. When four small curved figures are further created from the vertex A, a windmill-shaped figure with five wings like the picture is created.

When this process is performed at all the vertices of the regular icosahedron, the sphere is designed as twelve congruent five-winged windmills. As shown in FIG. 12 (c), the vertices of the regular icosahedron become the centers of each windmill, and the vertices of the regular dodecahedron become the points where three windmills meet.

### Example 6: Dual Polyhedron Design

A spherical housing simultaneously formed with through holes corresponding to the vertices of the cube and the regular octahedron corresponding to dual polyhedra was mounted therein with a transparent inner sphere, and then vertices were marked on all the through holes.

When twelve vertices of a regular icosahedron are connected to the inner sphere, a regular icosahedron forming equilateral triangles is completed. The centers of the equilateral triangles are marked and are connected to form a regular dodecahedron. Through this, the principle of the dual polyhedra is described.

### Example 7: Design of the Regular Polyhedra Cycle

A spherical housing simultaneously formed with through holes corresponding to all the vertices shown in FIG. 7 was mounted therein with a transparent inner sphere, and then vertices were marked on all the through holes.

The vertices of a cube are found on the inner sphere, and lines are connected to create a cube. A regular tetrahedron is created by connecting the four vertices of the cube. A regular octahedron is created by connecting the midpoints of edges of the regular tetrahedron. A regular icosahedron is created by connecting the golden ratio internal division points of edges of the regular octahedron. A regular dodecahedron is created by connecting the centroids of faces of the regular icosahedron. A cube is created using eight vertices of the regular dodecahedron.

### INDUSTRIAL APPLICABILITY

The present invention can be applied to a tool of spherical design play or learning for a learner.

1. A tool of spherical design play or learning for a learner, the tool of spherical design comprising:
a spherical housing comprising a first hemisphere and a second hemisphere that are detachably coupled to each other, are coupled to each other to form a sphere, and form a spherical receiving space therein; and
an inner spere mounted in the receiving space within the spherical housing,
wherein the first hemisphere and the second hemisphere comprise a plurality of through holes.

2. The tool of spherical design of claim 1, wherein end regions of the first hemisphere and the second hemisphere have a straight, wavy, or zigzag shape.

3. The tool of spherical design of claim 1, wherein the through holes correspond to vertices of a regular polyhedron.

4. The tool of spherical design of claim 3, wherein the regular polyhedron is one or more of a regular tetrahedron, a cube, a regular octahedron, a regular dodecahedron, and a regular icosahedron.

5. The tool of spherical design of claim 1, wherein the through holes are formed to correspond to all vertices of a cube and vertices of a regular octahedron, the cube and the regular octahedron corresponding to a dual polyhedron.

6. The tool of spherical design of claim 1, wherein the through holes are formed to correspond to all vertices of a regular dodecahedron and vertices of a regular icosahedron, the regular dodecahedron and the regular icosahedron corresponding to a dual polyhedron.

7. The tool of spherical design of claim 1, wherein the through holes are formed to correspond to all vertices of a regular polyhedron.

8. The tool of spherical design of claim 3, further comprising:
additional through holes not corresponding to vertices of the regular polyhedron.

9. A method for using a tool of spherical design, comprising steps of:
S1) coupling a first hemisphere and a second hemisphere each having a through hole to an inner sphere;
S2) marking vertices of a regular polyhedron on a surface of the inner sphere by using the through hole; and
S3) separating the inner sphere having the marked vertices and using the vertices to obtain a regular polyhedron or a repetitive pattern using the regular polyhedron.

10. A method for manufacturing a tool of spherical design, comprising steps of:
P1) finding vertices of a regular polyhedron by using a three-dimensional geometry program;
P2) modeling a first hemisphere and a second hemisphere by using a three-dimensional modeling program so that the vertices form through holes;
P3) adjusting diameters of the first hemisphere and the second hemisphere by using the three-dimensional modeling program according to a diameter of an inner sphere;
P4) preparing the modeled first and second hemispheres having the through holes using a three-dimensional printer; and
P5) providing a set of the first hemisphere and the second hemisphere and the inner sphere that is accommodatable in a receiving space formed by mutual coupling of the first hemisphere and the second hemisphere.
